(19) United States
(12) Patent Application Publication
(10) Pub. No.: US 2024/0269896 A1
(43) Pub. Date: Aug. 15, 2024

(54) SYSTEM AND METHOD FOR RECOVERING PLASTIC RECYCLING MATERIAL

(71) Applicant: Coperion GmbH, Stuttgart (DE)

(72) Inventors: Klaus Peter LANG, Bad Waldsee (DE); Bernhard STARK, Fronreute (DE)

(73) Assignee: Coperion GmbH, Stuttgart (DE)

(21) Appl. No.: 18/435,398

(22) Filed: Feb. 7, 2024

(30) Foreign Application Priority Data
Feb. 13, 2023 (DE) 10 2023 103 391.3

(51) Int. Cl. B29B 17/02; B29B 17/00

(52) U.S. Cl. CPC B29B 17/02; B29B 2017/0015

(57) ABSTRACT

A recovery system for recovering plastic recycling material includes at least one rinsing chamber designed for heating and rinsing the plastic recycling material and having a rinsing air feed for feeding heated rinsing air into the at least one rinsing chamber; and at least one cooling chamber designed for cooling the plastic recycling material and having a cooling air feed for feeding cooling air into the at least one cooling chamber. The at least one cooling chamber is connected downstream of the at least one rinsing chamber and is fluid-connected to the rinsing air feed via an exhaust air line in such a manner that the exhaust air heated in the at least one cooling chamber by the plastic recycling material can be fed into the rinsing air feed of the at least one rinsing chamber. Use of such recovery system and method for recovering plastic recycling material.

### CROSS-REFERENCE TO RELATED APPLICATION

This application claims priority to German Patent Application No. 10 2023 103 391.3, filed on Feb. 13, 2023, the entire contents of which are hereby incorporated by reference.

### DESCRIPTION

The disclosure relates to a recovery system and a use of a recovery system for recovering, particularly coiling, plastic recycling material. The disclosure also relates to a method for recovering, particularly coiling, plastic recycling material.

Plastic recycling material, such as post-consumer recyclates (PCR) obtained from disposable packaging or disposable PET bottles, is an important source of raw materials. Packaging waste is usually sorted, cleaned, shredded and processed into granulate using an extrusion and granulation system, which is a valuable and high-quality starting material (the PCR) for new products.

However, the plastic recycling material may have volatile components, particularly monomers, moisture, gases, such as air, solvents, odors and flavors, such as limonene, or other volatile organic compounds (VOCs). Limonene is a citrus-like flavor that may have been inserted into the packaging material by cosmetics or hygiene products, for example. Furthermore, undesirable flavors can arise from the packaged food and its decomposition processes. Often, the part of undesirable odors or flavors is still very high even after extrusion and granulation. A downstream process is therefore required to at least virtually remove the remaining undesirable, volatile components. Usually, the material to be treated must be heated to allow the VOCs to diffuse. The diffused VOCs must then be removed by a flushing fluid, for example with the aid of water or inert gas. Subsequently, the material to be treated must be cooled again. This high-energy overall process takes place with a separate heating container, degassing silo and downstream cooling container.

For example, DE 10 2012 206 017 A1 discloses a mixing apparatus by means of which bulk material can be mixed and coiled. When the bulk material is coiled, it is flushed with a gas to remove the volatile components.

The object of embodiments is to structurally and functionally improve a recovery system as described above. In addition, the object of embodiments is to structurally or functionally improve a method for recovering plastic recycling material as mentioned at the beginning.

It is therefore an object of embodiments to provide an energy-optimized recovery system consisting of as few components as possible and short piping routes, which enables the removal of undesirable volatile components, such as VOCs, to a sufficient extent.

The object is solved with a recovery system with the features of claim 1 or with the use of a recovery system with the features of claim 16. The object is further achieved by a method having the features of claim 17. Advantageous embodiments and/or further embodiments are the subject matter of the subclaims, the description and/or the accompanying figures. In particular, the independent claims of one claim category may also be combined analogously to the dependent claims of another claim category. The device and method features described below can also be combined with one another.

One aspect relates to a recovery system for recovering plastic recycling material. Recovering can be or comprise coiling, deodorizing and/or degassing. The recovery system can also be a rinsing system, a deodorization system or a degassing and deodorization system.

The plastic recycling material may be or comprise post-consumer recyclate and/or plastic waste, such as post-consumer plastic waste. In embodiments, the plastic recycling material is in the form of plastic particles, which can be washed and/or cleaned. Depending on the particle size and/or particle shape, the plastic particles can be in the form of plastic granules, plastic flakes or plastic powder, for example. In particular, the plastic recycling material or the plastic particles form bulk material that has been processed or produced by means of an extrusion and granulation system. The plastic recycling material may also have been shredded.

The recovery system has at least one rinsing chamber for heating and coiling the plastic recycling material. The rinsing chamber can be designed to coil and degas the plastic recycling material. Rinsing can be a deodorizing process. A rinsing air feed is further provided for feeding heated rinsing air into the rinsing chamber. The rinsing air can be ambient air.

Furthermore, the recovery system has at least one cooling chamber for cooling the plastic recycling material. The cooling chamber is connected to a cooling air supply for feeding, for example, cooled or cold cooling air into the cooling chamber. The cooling air can have a temperature that corresponds to the ambient air or is lower than the rinsing air. For example, the cooling air can be ambient air. If lower temperatures are required, the cooling air can be actively cooled, for example via a heat exchanger.

The cooling chamber is located downstream of the rinsing chamber, i.e. downstream of the rinsing chamber in the direction of bulk material flow. The rinsing chamber and the cooling chamber can be arranged and/or connected in series. According to embodiments, it was recognized that it is advantageous from an energy point of view to connect the cooling chamber to the rinsing air feed via an exhaust air line. As a result, the cooling chamber and the rinsing air feed are fluid-connected in such a manner that the exhaust air heated in the cooling chamber by the plastic recycling material can be fed into the rinsing air feed of the rinsing chamber.

In embodiments, the rinsing chamber can be a rinsing container and the cooling chamber a cooling container. In one embodiment, the rinsing chamber and cooling chamber can be integrated in a common container. This further reduces the number of containers. The rinsing container and the cooling container may each have a material inlet, e.g. a material inlet opening, and a material outlet, e.g. a material outlet opening. Further, the containers can be connected to one another by means of a material conveyor line, for example. The material outlet of the rinsing container can be connected to the material inlet of the cooling container via such a material conveyor line. The containers can be designed to be cylindrical, for example. The containers can have a substantially round, circular, oval or square cross-section.

The containers can have substantially the same cross-section. In one embodiment, the rinsing container can have a larger cross-section than the cooling container. The rinsing container and the cooling container can have substantially the same height, e.g. cylindrical height. Alternatively, the rinsing container can have a greater height than the cooling container. Containers with a holding volume of between 5 and 1000 m³ are particularly suitable for this purpose.

The containers can have a cylindrical part and a tapered part, e.g. in the shape of a cone. The tapered part can be directly connected to the cylindrical part. The tapered part, seen in the direction of material flow, can be provided after the cylindrical part. In embodiments, the cylindrical part is circular-cylindrical. The material inlet can be provided on the cylindrical part and the material outlet can be provided on the tapered part. In one embodiment, the lower part of the container tapers towards the material outlet.

The recovery system can be designed for continuous or discontinuous operation, for example for continuous or discontinuous filling of the rinsing container and/or the cooling container. Additionally or alternatively, the recovery system can be designed for continuous or discontinuous discharge or removal of the plastic recycling material. It is particularly advantageous that the recovery system can be operated extremely energy- efficiently in continuous operation.

A first dosing device can be effectively arranged between the rinsing container and the cooling container. In embodiments, the first dosing device is integrated into the material feed line connecting the rinsing container and cooling container. The first dosing device can be used to feed the plastic material rinsed in the rinsing container. Recycling material into the cooling container. For example, the first dosing device can be or comprise a sluice, particularly a rotary valve, a slide, a flap or a screw. In embodiments, the first dosing device is used to continuously pick up and/or continuously dispense or feed the plastic recycling material rinsed in the rinsing container. In one embodiment, the first dosing device can be designed to control the material dispensing or feeding into the cooling container based on a fill level of the rinsing container and/or based on an amount of plastic recycling material present in the rinsing container. For this purpose, a sensory system can be provided that is configured to detect the fill level of the rinsing container and/or the amount of plastic recycling material present in the rinsing container. The fill level or the amount of material in the rinsing container can thus be controlled and kept at a determined level or value, for example constant. In this case, the recovery system and/or the first dosing device can be designed to effect a continuous flow of plastic recycling material through the rinsing container. The first dosing device can be controlled depending on the treatment time and/or required throughput.

The recovery system may further have a second dosing device downstream of the at least one cooling container. The second dosing device can be integrated into a material feed line connected to the material outlet of the cooling container. The second dosing device can be designed to discharge the plastic recycling material cooled in the cooling container. In embodiments, the second dosing device is used to continuously pick up and/or continuously dispense or discharge the plastic recycling material cooled in the at least one cooling container. The second dosing device can be designed like the first dosing device described above and/or below. In one embodiment, the second dosing device may be designed to control the material dispensing or discharge based on a fill level of the at least one cooling container and/or an amount of plastic recycling material present in the at least one cooling container. For this purpose, a sensory system can be provided which is configured to detect the fill level of the at least one cooling container and/or the amount of plastic recycling material present in the at least one cooling container. The fill level or the amount of material in the at least one cooling container can thus also be controlled and kept at a determined level or value, for example constant. In this case, the recovery system and/or the second dosing device may be designed to effect a continuous flow of plastic recycling material through the at least one cooling container.

The rinsing air feed can comprise at least one rinsing air line that opens into the rinsing chamber. One or more feed points can be provided at which the rinsing air line opens into the rinsing chamber. For example, the rinsing air line can lead into the rinsing chamber at two, three or more feed points. The feed points can be arranged at a vertical distance from one another. This enables rinsing air to be supplied at different levels in the rinsing chamber. Additionally or alternatively, a uniform distribution of the rinsing air along the circumference of the rinsing chamber can be achieved by arranging the feed points at a distance from one another in a horizontal plane. The feed points can be injection points or air connections. The arrangement of the feed points in the area of the tapering part of the flushing chamber is particularly advantageous. In one embodiment, at least one feed point can also be provided on the material feed line connected to the material outlet of the rinsing chamber. This allows the rinsing air line to flow into the material conveyor line, so that rinsing air can be blown into the rinsing chamber from below. The rinsing air line can be designed in several parts, for example having several partial line portions. The rinsing air line can have at least one branch, for example a T-or Y-branch. Particularly advantageous is a substantially evenly distributed flow of rinsing air across the cross-section of the rinsing chamber from bottom to top, wherein the rinsing air flows through the plastic recycling material present in the rinsing chamber. In embodiments, rinsing air can be used for countercurrent rinsing. It is also substantially important that the rinsing air line is kept free of the plastic granulate. For this purpose, a retaining element, such as a hat screen or perforated plate, can be arranged at the feed points so that the plastic granulate from the rinsing chamber cannot get into the rinsing air line. This prevents the rinsing air line from becoming blocked.

The recovery system may have a heating apparatus for tempering, for example heating, the rinsing air. In embodiments, the rinsing air line is effectively coupled with the heating apparatus. The rinsing air line can extend through the heating apparatus or the rinsing air line can be surrounded by the heating apparatus, at least in portions. The heating apparatus can be electrically or non-electrically operated. The heating apparatus can have at least one heating coil or at least one heating channel, for example for a heating medium. Thermal oil, steam, hot water or flue gas, e.g. from the exhaust air of existing auxiliary systems, can be used as the heating medium. The heating apparatus can, for example, be designed as a gas flow heater or air heater.

The cooling air feed can comprise at least one cooling air line that opens into the cooling chamber. One or more feed points can be provided at which the cooling air line flows into the cooling chamber. For example, the cooling air line can enter the cooling chamber at two, three or more feed points. The feed points of the cooling chamber can be designed in the same manner as the feed points of the rinsing chamber described above and/or below. The feed points can thus be arranged vertically and/or horizontally spaced from one another. They can be offset radially and in height. Furthermore, one or more ring lines can be formed, each with at least one feed point, e.g. in the form of a spigot. The arrangement of the feed points in the area of the tapering part of the cooling chamber is also particularly advantageous here. In embodiments, at least one feed point can also be provided on the material feed line connected to the material outlet of the cooling chamber. This allows the cooling air line to flow into the material conveyor line, allowing cooling air to be blown into the cooling chamber from below. The cooling air line can be designed like the rinsing air line described above and/or below. Here too, it is particularly advantageous for the cooling air to flow through the cooling chamber substantially evenly across the cross-section from bottom to top, so that the plastic recycling material in the cooling chamber is flowed through with cooling air from bottom to top. In embodiments, cooling can be carried out with cooling air using the counterflow method. A retaining element to prevent plastic granulate from entering the cooling air line can also be provided at the feed points.

The recovery system can have a cooling apparatus for tempering the cooling air. This enables active cooling of the cooling air. The cooling air line can be effectively coupled with the cooling apparatus. For example, the cooling air line can extend through the cooling apparatus or the cooling air line can be surrounded by the cooling apparatus, at least in portions. The cooling apparatus can be electrically or non-electrically operated. For example, the cooling apparatus can have at least one cooling channel for a cooling medium.

The rinsing air feed can comprise a first fan for supplying rinsing air. The cooling air supply can comprise a second fan for cooling air feed. The first and/or the second fan can be designed as a pressure fan. In one embodiment, the first fan can be designed as a suction/pressure fan, which means that the second fan can then be omitted. The first fan can be designed for tempering, for example heating, the rinsing air. For example, the first fan can be designed to heat the rinsing air by means of compression heat. The second fan can be designed for tempering, for example cooling, the cooling air. The rinsing air line can be effectively coupled with the first fan. The first fan can be integrated into the rinsing air line. In a variant, the first fan can be effectively coupled to the exhaust air line of the cooling chamber. The cooling air line can be effectively coupled with the second fan. The second fan can be integrated into the cooling air line. Additionally or alternatively, a suction fan or a suction/pressure fan can be provided in the exhaust air line of the cooling chamber.

The exhaust air line of the cooling chamber can lead into the rinsing air line. A dust separator can be effectively connected between the exhaust air line of the cooling chamber and the rinsing air line. The exhaust air from the cooling chamber can therefore first be conveyed into the dust separator before it enters the rinsing air line. For example, the exhaust air line of the cooling chamber can open into the rinsing air line on the inlet side of the first fan. Alternatively, the exhaust air line of the cooling chamber can also open into the rinsing air line between the first fan and the heating apparatus.

Further, an exhaust air line can be connected to the rinsing chamber to remove the rinsing air including the volatile components, such as VOCs, of the plastic recycling material. A fan, for example a suction fan, can be provided in the exhaust air line of the rinsing chamber.

The rinsing air feed can be coupled with a steam feed. The steam feed can be designed to feed steam into the rinsing air. The steam feed can be effectively arranged before or after the heating apparatus. Alternatively, a water injection system can be provided to inject water into the rinsing air. The water injection can be effectively arranged upstream of the heating apparatus.

Two, three, four, five or more flushing chambers can be connected in parallel. Additionally or alternatively, two, three, four or more cooling chambers can be connected in parallel. In one embodiment, two or more cooling chambers connected in parallel can be provided with a single rinsing chamber upstream of the cooling chambers.

The recovery system can heat the plastic recycling material, particularly to a temperature of approximately 80 to 100° C., by means of the rinsing air. Further, the recovery system may be designed such that the plastic recycling material can be held in the respective chamber or container with a residence time, e.g. average residence time, of approximately 5 to 25 hours. In embodiments, the recovery system can be designed in such a way that a throughput, such as material throughput, of approximately 0.5 to 25 tons per hour can be achieved.

The recovery system can be designed for implementing a method, e.g. the method described below, for recovering plastic recycling material, for example post-consumer recyclate.

A further aspect relates to a use of the recovery system described above and/or below for recovering, particularly rinsing, plastic recycling material, for example post-consumer recyclate.

Another aspect relates to a method for recovering plastic recycling material, for example post-consumer recyclate. The method can be a plastic preparation method, a rinsing method and/or a deodorization method. The method can also be a degassing and deodorizing process. In embodiments, the method can be designed for degassing and/or rinsing or deodorizing plastic recycling material. The method can, for example, be applied to and/or performed with the recovery system described above and/or below.

First of all, plastic recycling material, particularly that which is to be rinsed or deodorized, can be fed to at least one rinsing chamber of the recovery system. Feeding can be continuous or discontinuous. Feeding can also be understood as filling.

The plastic recycling material can then be heated and rinsed in the rinsing chamber, particularly by means of heated rinsing air fed into the rinsing chamber via a rinsing air feed. The plastic recycling material can be heated to a temperature of approximately 80 to 100° C. by the rinsing air, for example. The residence time, or average residence time, of the plastic recycling material in the rinsing chamber can be approximately 5 to 25 hours.

The plastic recycling material that has been rinsed and heated in the rinsing chamber can then be fed into at least one cooling chamber of the recovery system. Feeding can be continuous or discontinuous.

The rinsed and heated plastic recycling material can be cooled inside the cooling chamber. This is done particularly by means of cooling air fed into the at least one cooling chamber via a cooling air feed. The rinsed and heated plastic recycling material can be cooled by the cooling air to a temperature below 60° C., for example. Cooling can also be understood as active cooling. The residence time, such as average residence time, of the rinsed and heated plastic recycling material in the at least one cooling chamber can be approximately 5 to 25 hours.

According to embodiments, the exhaust air heated in the at least one cooling chamber by the rinsed plastic recycling material can be fed into the rinsing air feed of the rinsing chamber. The heated exhaust air can be dedusted before being fed into the system.

The cooled plastic recycling material can be discharged from the cooling chamber. The discharge can be continuous or discontinuous, for example by feeding into a material conveyor line.

With this method, the throughput, such as material throughput, can be approximately 0.5 to 25 tons per hour. Further, the flow speed of the rinsing air and/or the cooling air can be approximately 0.1 to 1 m/s. The relative humidity of the heated rinsing air can be approximately 60 to 90%. With the recovery system and method according to embodiments, it can be achieved that the volatile components, such as VOCs, are below <1 ppm after treating.

Embodiments thus result in an energy-optimized recovery system and/or recovery process, particularly for post-consumer recyclates (PCR), wherein the plastic material in the rinsing chamber can move moderately or be kept in a kind of suspended state during rinsing by feeding in heated rinsing air in a countercurrent process, wherein the warm exhaust air from the cooling chamber is used to heat the rinsing air. As a result, the major part of the energy remains in the system.

Embodiments can therefore provide an energy-optimized system with as few components as possible, which enables the removal of undesirable volatile components, such as VOCs, to a sufficient extent. The system can be operated continuously and energy-efficiently, utilizing the thermal energy introduced. As a result, significant energy savings of around 80% can be achieved.

Exemplary embodiments are described in more detail below with reference to figures, in which the following are shown schematically and by way of example:

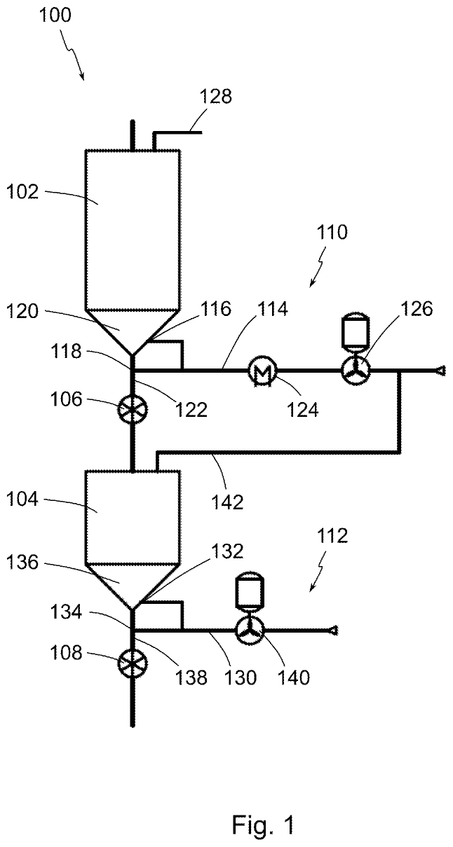

FIG. 1 shows a recovery system for recovering plastic recycling material.

FIG. 1 shows a schematic embodiment of a recovery system 100 for recovering plastic recycling material, particularly post-consumer recyclate. The recovery system 100 is designed for continuous operation and comprises a rinsing container 102 designed as a rinsing chamber and a cooling container 104 designed as a cooling chamber. The rinsing container 102 is designed to heat and rinse or deodorize the plastic recycling material. The cooling container 104 is designed to cool the plastic recycling material.

The cooling container 104 is arranged downstream of the rinsing container 102, wherein a first dosing device 106 is operatively arranged between the rinsing container 102 and the cooling container 104 for supplying the plastic recycling material rinsed in the rinsing container 102 to the cooling container 104. In the present exemplary embodiment, the first dosing device 106 is designed as a rotary valve for continuously feeding the rinsed plastic recycling material into the cooling container 104. Particularly, the rotary valve 106 can receive the rinsed plastic recycling material based on a fill level of the rinsing container 102 and deliver it to the cooling container 104. This allows the cooling container 104 to be continuously filled with the rinsed plastic recycling material.

The recovery system 100 further has a second dosing device 108, which is connected downstream of the cooling container 104 and is designed to discharge the plastic recycling material cooled in the cooling container 104. In the present exemplary embodiment, the second dispensing device 108 is also designed as a rotary valve for continuously dispensing the cooled plastic recycling material. In particular, the rotary valve 108 can receive and dispense the cooled and rinsed plastic recycling material based on a fill level of the cooling container 104. This means that the cooled and rinsed plastic recycling material can be continuously discharged, for example to a collection container or fed into a material conveyor line for transportation to a further processing system.

In addition, the recovery system 100 has a rinsing air feed 110 for feeding heated rinsing air into the rinsing container 102 and a cooling air feed 112 for feeding cooling air into the cooling container 104.

The rinsing air feed 110 comprises a rinsing air line 114 which opens into the rinsing container 102 at two feed points 116, 118 at the bottom. The first feed point 116 is located at the bottom of a tapered part 120 of the cylindrical rinsing container 102, and the second feed point 118 is located on a material feed line 122 leading from the rinsing container 102 to the first dosing device 106. This allows the heated rinsing air to be blown in at the bottom of the rinsing container 102 and to rinse the plastic recycling material to be rinsed in a counterflow process.

The rinsing air feed 110 further comprises a heating apparatus 124 which is operatively coupled to the rinsing air line 114 for tempering, particularly heating, the rinsing air. Further, the rinsing air feed 110 has a first fan 126 for supplying rinsing air, which is coupled to the rinsing air line 114 such that rinsing air can be blown into the rinsing air line 114. In the present exemplary embodiment, the first fan 126 is designed as a pressure fan. Alternatively, the first fan 126 may be designed as a suction-pressure fan. In order to allow the rinsing air introduced into the rinsing container 102 together with the volatile components, such as VOCs, of the rinsed plastic recycling material to escape upwardly from the rinsing container 102, an exhaust duct 128 is connected to the top of the rinsing container 102 for discharging the rinsing air together with the volatile components.

The cooling air feed 112 comprises a cooling air line 130 which opens into the cooling container 104 at two feed points 132, 134 at the bottom. The first feed point 132 is located at the bottom of a tapered part 136 of the cylindrical cooling container 104, and the second feed point 134 is located on a material conveying line 138 leading from the cooling container 104 to the second dosing device 108. This allows the cooling air to be blown in at the bottom of the cooling container 104 and flush the rinsed plastic recycling material to be cooled in a counterflow process.

The cooling air feed 112 further comprises a second fan 140 for supplying cooling air, which is coupled to the cooling air line 130 such that cooling air can be blown into the cooling air line 130. The cooling air can, for example, be ambient air that has been drawn in. In the present exemplary embodiment, the second fan 126 is designed as a pressure fan.

In order to allow the cooling air or exhaust air introduced into the cooling container 104 and heated by the rinsed plastic recycling material to escape upwards out of the cooling container 104, an exhaust air line 142 for discharging the heated cooling exhaust air is connected to the top of the cooling container 104. The cooling container 104 is fluidly connected to the rinsing air feed 114 via the exhaust air line 142 in such a manner that the cooling exhaust air heated in the cooling container 104 by the rinsed plastic recycling material can be fed into the rinsing air feed 110. As shown in FIG. 1, the exhaust air line 142 of the cooling container 104 opens into the rinsing air line 114 on the inlet side of the first fan 126. As a result, the heated exhaust air from the cooling container 104 can be mixed with the rinsing air and used to heat and rinse the plastic recycling material to be rinsed in the rinsing container 102. This type of connection or recirculation of the heated exhaust air means that a major part of the heat energy can remain in the system and be utilized. The recovery system 100 can thus be operated much more energy-efficiently.

The term “may” refers in particular to optional features of embodiments. Accordingly, there are also developments and/or exemplary embodiments which additionally or alternatively have the respective feature or the respective features.

From the feature combinations disclosed in herein, isolated features may also be singled out as required and, by resolving an optionally existing structural and/or functional relationship between the features in combination with other features, be used to delimit the subject matter of the claim. The order and/or number of method steps may be varied.

### REFERENCE SIGNS

100 recovery system
102 rinsing container/rinsing chamber
104 cooling container/cooling chamber
106 first dosing device/rotary valve
108 second dosing device/rotary valve
110 rinsing air feed
112 cooling air feed
114 rinsing air line
116 feed point
118 feed point
120 tapered part
122 material conveyor line
124 heating apparatus
126 first fan/pressure fan
128 exhaust air line
130 cooling air line
132 feed point
134 feed point
136 tapered part
138 material conveyor line
140 second fan/pressure fan
142 exhaust air line

1. A recovery system for recovering plastic recycling material, comprising:
at least one rinsing chamber designed for heating and rinsing the plastic recycling material, with a rinsing air feed for feeding heated rinsing air into the at least one rinsing chamber; and
at least one cooling chamber designed for cooling the plastic recycling material with a cooling air feed for feeding cooling air into the at least one cooling chamber, wherein the at least one cooling chamber is connected downstream of the at least one rinsing chamber and is fluidly connected to the rinsing air feed via an exhaust air line in such a manner that the exhaust air heated by the plastic recycling material in the at least one cooling chamber can be fed into the rinsing air feed of the at least one rinsing chamber.

2. The recovery system according to claim 1, wherein the recovery system is designed for continuous operation.

3. The recovery system according to claim 1, wherein the at least one rinsing chamber is a rinsing container and the at least one cooling chamber is a cooling container.

4. The recovery system according to claim 3, wherein a first dosing device is effective between the at least one rinsing container and the at least one cooling container for continuously feeding the plastic recycling material rinsed in the at least one rinsing container into the at least one cooling container.

5. The recovery system according to claim 4, wherein the first dosing device is designed to control the feed into the at least one cooling container based on a fill level of the at least one rinsing container and/or based on an amount of plastic recycling material present in the at least one rinsing container.

6. The recovery system according to claim 3, wherein a second dosing device is provided, which is connected downstream of the at least one cooling container and is designed for continuously discharging the plastic recycling material cooled in the at least one cooling container.

7. The recovery system according to claim 6, wherein the second dosing device is designed to control the discharge of the cooled plastic recycling material based on a fill level of the at least one cooling container and/or based on an amount of plastic recycling material present in the at least one cooling container.

8. The recovery system according to claim 1, wherein the rinsing air feed comprises a rinsing air line which is operatively coupled to a heating apparatus for tempering the rinsing air.

9. The recovery system according to claim 1, wherein the rinsing air feed comprises a first fan for supplying rinsing air, and/or in that the cooling air feed comprises a second fan for supplying cooling air.

10. The recovery system according to claim 9, wherein the first fan and/or the second fan is designed as a pressure fan, and/or in that the first fan is designed as a suction-pressure fan.

11. The recovery system according to claim 8, wherein the exhaust air line of the at least one cooling chamber, on the inlet side of the first fan or between the first fan and the heating apparatus, opens into the rinsing air line.

12. The recovery system according to claim 1, wherein a suction fan or a suction-pressure fan is provided in the exhaust air line of the at least one cooling chamber.

13. The recovery system according to claim 1, wherein an exhaust air line for discharging the rinsing air and the volatile components, such as vocs, of the plastic recycling material is connected to the at least one rinsing chamber, wherein a suction fan is provided in the exhaust air line of the at least one rinsing chamber.

14. The recovery system according to claim 1, wherein the rinsing air feed is coupled to a steam feed for feeding steam or a water injection for injecting water into the rinsing air.

15. The recovery system according to claim 1, wherein a plurality of rinsing chambers are connected in parallel with one another, and/or in that a plurality of cooling chambers are connected in parallel with one another.

16. A use of a recovery system according to claim 1 for recovering, in particular rinsing, plastic recycling material, in particular post-consumer recyclate.

17. A method for recovering plastic recycling material comprising the following steps:
heating and rinsing of the plastic recycling material in at least one rinsing chamber by means of heated rinsing air fed into the at least one rinsing chamber via a rinsing air feed;
continuously feeding the plastic recycling material rinsed in the at least one rinsing chamber to at least one cooling chamber;
cooling the plastic recycling material within the cooling chamber by means of cooling air fed into the at least one cooling chamber via a cooling air feed; and
feeding the exhaust air heated by the plastic recycling material in the at least one cooling chamber into the rinsing air feed of the at least one rinsing chamber.
